(19) United States
(12) Patent Application Publication
(10) Pub. No.: US 2001/0042788 A1
(43) Pub. Date: Nov. 22, 2001

(54) IMAGE PROCESSING APPARATUS, IMAGE PROCESSING METHOD AND IMAGE PROCESSING PROGRAM STORAGE MEDIUM

(76) Inventors: KEIGO IHARA, CHIBA (JP); SHINJI NAKAJIMA, CHIBA (JP); JUNICHI REKIMOTO, TOKYO (JP); TAKAHIKO SUEYOSHI, TOKYO (JP)

Correspondence Address: WILLIAM S. FROMMER, ESQ., C/O FROMMER LAWRENCE & HAUG LLP, 745 FIFTHE AVENUE, NEW YORK, NY, 10151, US

(21) Appl. No.: 09/385,720

(22) Filed: Aug. 30, 1999

(30) Foreign Application Priority Data
Aug. 31, 1998 (JP) 10-245855

(51) Int. Cl. G06K 7/10

(52) U.S. Cl. 235/462.11

(57) ABSTRACT

The invention relates to an image processing apparatus comprising: an image acquiring element for acquiring an object image; a displaying element for displaying the object image acquired by the image acquiring element; an identification information recognizing element for recognizing, from the object image acquired by the image acquiring element, identification information representing each of a plurality of predetermined image patterns; a retrieving element for retrieving, based on previously input retrieval information, identification information coinciding with the identification information recognized by the identification information recognizing element; and a cursor display controlling element for displaying, based on results of the retrieving by the retrieving element, a cursor in a position corresponding to the predetermined image pattern displayed by the displaying element.

### BACKGROUND OF THE INVENTION

The present invention relates to an image processing apparatus, an image processing method, and an image processing program storage medium. More particularly, the invention relates to an image processing apparatus, an image processing method, and an image processing program storage medium whereby identification information coinciding with given retrieval information is retrieved from identification information acquired illustratively from a plurality of two-dimensional codes, so that an outcome of the retrieving is displayed in the same position as that of the two-dimensional code corresponding to the retrieved identification information.

Illustratively, floppy disks are used extensively as a storage medium for use by personal computers and like equipment. These floppy disks usually bear labels describing titles, write dates, etc., identifying stored information so as to help users pick specific disks containing desired information. Other storage media such as cassette tapes and video tapes are also furnished with similar labels.

One disadvantage of such identification by label is its time-consuming nature: it takes time for the user to visually check labels, one at a time, of individual floppy disks.

Meanwhile, the so-called bar code system is used extensively in diverse industrial fields. The system involves encoding in bars alphanumeric characters representing ID numbers and other relevant information about goods and articles, and typically attaching bar-based codes to these goods and products so that the codes may later be scanned by an optical recognition apparatus called a bar code scanner for retrieval of relevant ID information.

Illustratively, ID numbers of products are obtained by the scanner scanning their bar codes at cash registers or like equipment in retail stores. With the ID numbers thus acquired, previously stored product prices corresponding to the obtained numbers are retrieved from a database and displayed on a display device.

A conventional bar code system of the above type may conceivably be utilized in looking for a floppy disk including desired information.

In such a case, however, all floppy disks bearing labels with bar codes printed thereon must be scanned one at a time by a bar code scanner for identification. The procedure is bothersome, and it has been difficult to apply the complex and expensive bar code system to personal computers or like general-purpose equipment for household use.

### SUMMARY OF THE INVENTION

It is therefore an object of the present invention to overcome the above and other deficiencies of the prior art and to provide an apparatus and a method for allowing desired objects to be picked easily through the simple input of retrieval information.

In carrying out the invention and according to one aspect thereof as defined in the appended claim 1, there is provided an image processing apparatus comprising: image acquiring means for acquiring an object image; displaying means for displaying the object image acquired by the image acquiring means; identification information recognizing means for recognizing, from the object image acquired by the image acquiring means, identification information representing each of a plurality of predetermined image patterns; retrieving means for retrieving, based on previously input retrieval information, identification information coinciding with the identification information recognized by the identification information recognizing means; and cursor display controlling means for displaying, based on results of the retrieving by the retrieving means, a cursor in a position corresponding to the predetermined image pattern displayed by the displaying means.

According to another aspect of the invention as defined in the appended claim 6, there is provided an image processing method comprising the steps of: acquiring an object image; displaying the object image acquired in the image acquiring step; recognizing, from the object image acquired in the image acquiring step, identification information representing each of a plurality of predetermined image patterns; retrieving, based on previously input retrieval information, identification information coinciding with the identification information recognized in the identification information recognizing step; and displaying, based on results of the retrieving in the retrieving step, a cursor in a position corresponding to the predetermined image pattern displayed in the displaying step.

According to a further aspect of the invention as defined in the appended claim 7, there is provided an image processing program storage medium for storing an image processing program in a manner executable by a computer, the image processing program comprising the steps of: acquiring an object image; displaying the object image acquired in the image acquiring step; recognizing, from the object image acquired in the image acquiring step, identification information representing each of a plurality of predetermined image patterns; retrieving, based on previously input retrieval information, identification information coinciding with the identification information recognized in the identification information recognizing step; and displaying, based on results of the retrieving in the retrieving step, a cursor in a position corresponding to the predetermined image pattern displayed in the displaying step.

Through the use of the inventive image processing apparatus according to claim 1, image processing method according to claim 6 and image processing program storage medium according to claim 7 outlined above, an item of identification information representing each of a plurality of predetermined image patterns is recognized from a captured object image. Of the multiple items of identification information thus recognized, one that corresponds to previously input retrieval information is retrieved. A cursor reflecting the retrieved identification information is displayed in a position corresponding to the image pattern being displayed.

Other objects, features and advantages of the invention will become more apparent upon a reading of the following description and appended drawings.

### BRIEF DESCRIPTION OF THE DRAWINGS

FIG. 1 is a schematic view showing a use example of a personal computer 1 to which the invention is applied;

FIG. 2 is an explanatory view depicting specifications of a two-dimensional code;

FIG. 3 is a perspective view of a portable personal computer embodying the invention, with its display part swung open away from its body;

FIG. 4 is a plan view of the computer in FIG. 3;

FIG. 5 is a left-hand side view of the computer in FIG. 3 with its display part swung shut onto its body;

FIG. 6 is a right-hand side view of the computer in FIG. 3 with its display part swung open 180 degrees relative to its body;

FIG. 7 is a front view of the computer in FIG. 5;

FIG. 8 is a bottom view of the computer in FIG. 6;

FIG. 9 is a block diagram showing an internal structure of the personal computer 1 in FIG. 3;

FIG. 10 is a schematic view indicating a structure of an HDD 56 in FIG. 9;

FIG. 11 is a flowchart of steps constituting a 2D code retrieval process;

FIG. 12 is a schematic view sketching a typical display on an LCD 21 in FIG. 3; and

FIG. 13 is a schematic view depicting another typical display on the LCD 21 in FIG. 3.

### DETAILED DESCRIPTION OF THE PREFERRED EMBODIMENTS

Preferred embodiments of this invention will now be described with reference to the accompanying drawings.

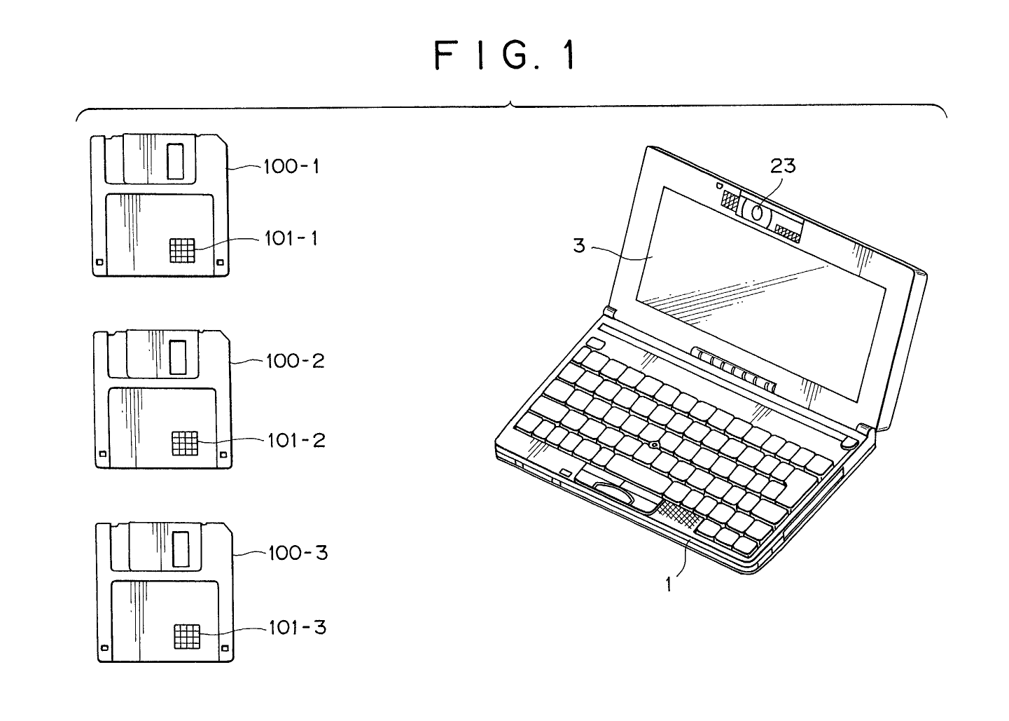

FIG. 1 is a schematic view depicting a use example of a personal computer 1 to which the invention is applied. In this example, there are three floppy disks 100-1 through 100-3 having specific information written thereon beforehand (hereinafter the disks will be generically referred to as the floppy disk 100 if distinction between individual disks is unnecessary; the same convention also applies to other parts hereunder where appropriate). The floppy disks 100-1 through 100-3 bear labels having two-dimensional codes 101-1 through 101-3 printed respectively thereon. The two-dimensional code 101 may simply be called the 2D code where appropriate.

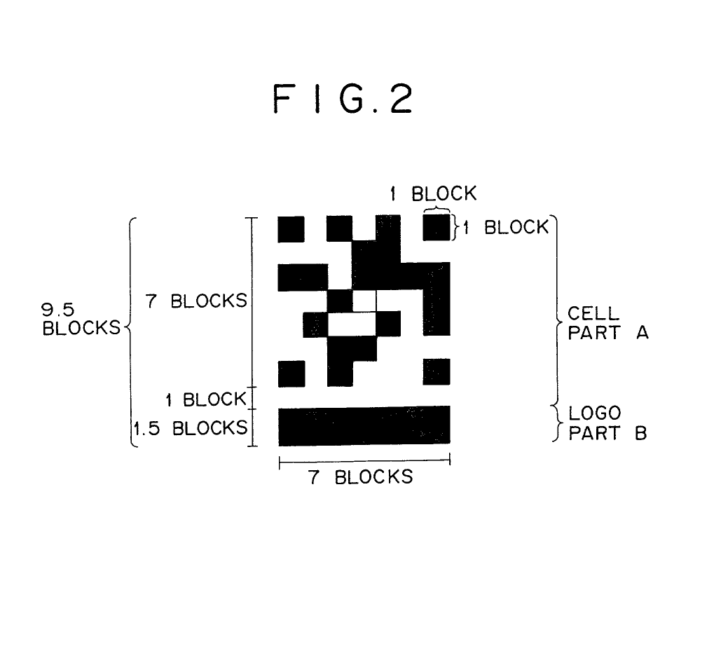

As shown in FIG. 2, the 2D code 101 constitutes a block unit-based rectangle measuring 9.5 blocks by 7 blocks. The rectangle comprises a cell part A and a logo part B, in black, separated by a single block space. The cell part A forms a square of 7 blocks per side comprising square cells arranged in a two-dimensional pattern. The logo part B includes a large-sized rectangle measuring 1.5 blocks by 7 blocks. Illustratively, the logo part B has a hollowed logo mark such as “CyberCode (registered trademark) printed in blanks against a black background representing the code system name of the 2D code 101.

Illustratively, the following description is available at the time of submitting this application from the home page offered by this applicant at (URL): http://www.sony.co.jp/sd/ProductsPark/Consumer/PCOM/PCG-C1CAT/cybercode.html

“What we call “CyberCode” is Sony's unique two-dimensional code system that offers about 16.77 million different data (in 24 bits). Of these patterns, about one million data (in 20 bits) may be registered as desired for program start-up purposes. The remaining code data are reserved for future service expansion. “CyberCode” works as an index to what is represented by the code in question, the index allowing relevant information to be retrieved from computer storage. When a user starts a program through a new interface feature “CyberCode Finder,” the user finds that the corresponding information leaps from the object having the “CyberCode” onto the computer screen.”

The personal computer 1 is a notebook type computer comprising a CCD video camera 23 located in a display part 3. Illustratively, the personal computer 1 recognizes a pattern of the 2D code 101 on the basis of image data about the object 100 and 2D code 101, the image data being acquired by the CCD video camera 23. The personal computer 1 performs a process in accordance with the pattern of the 2D code 101 thus obtained.

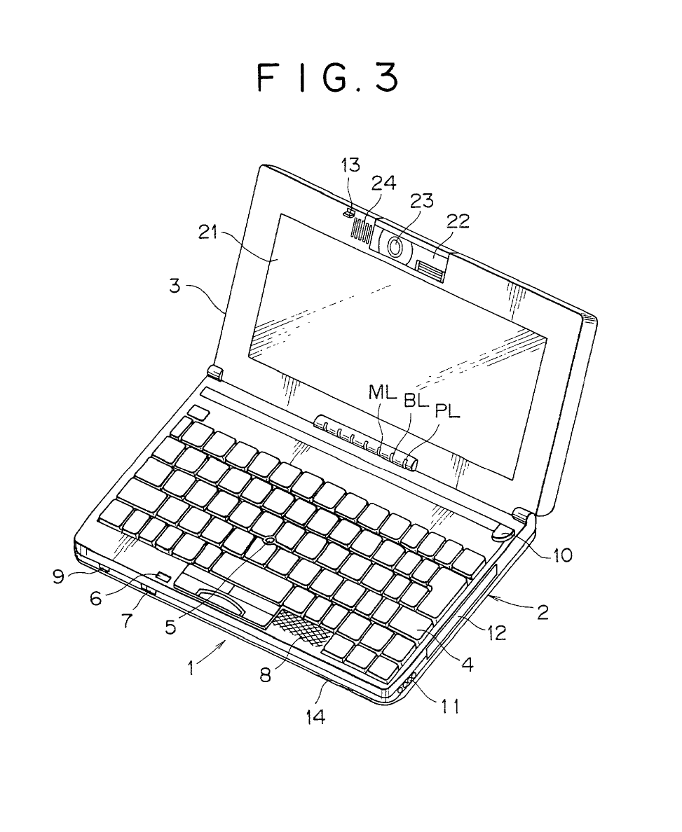

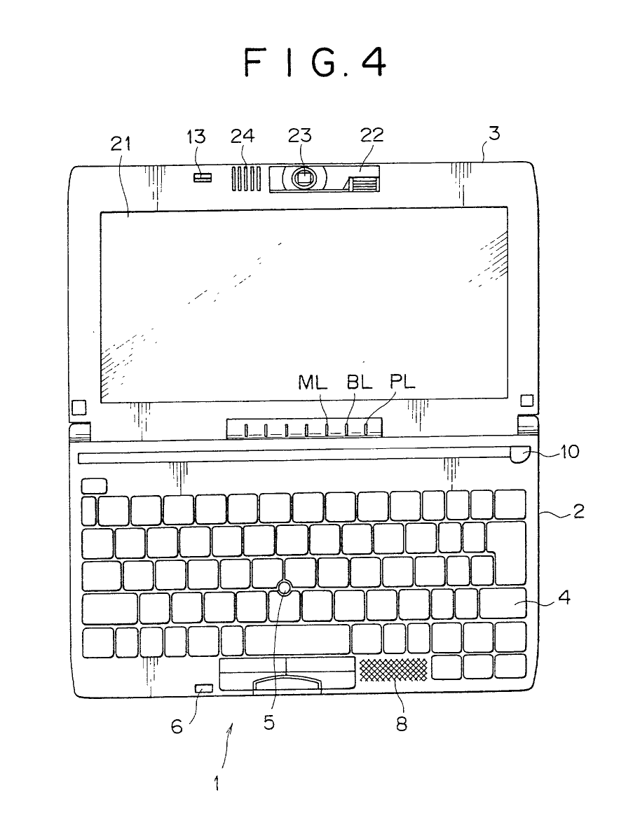

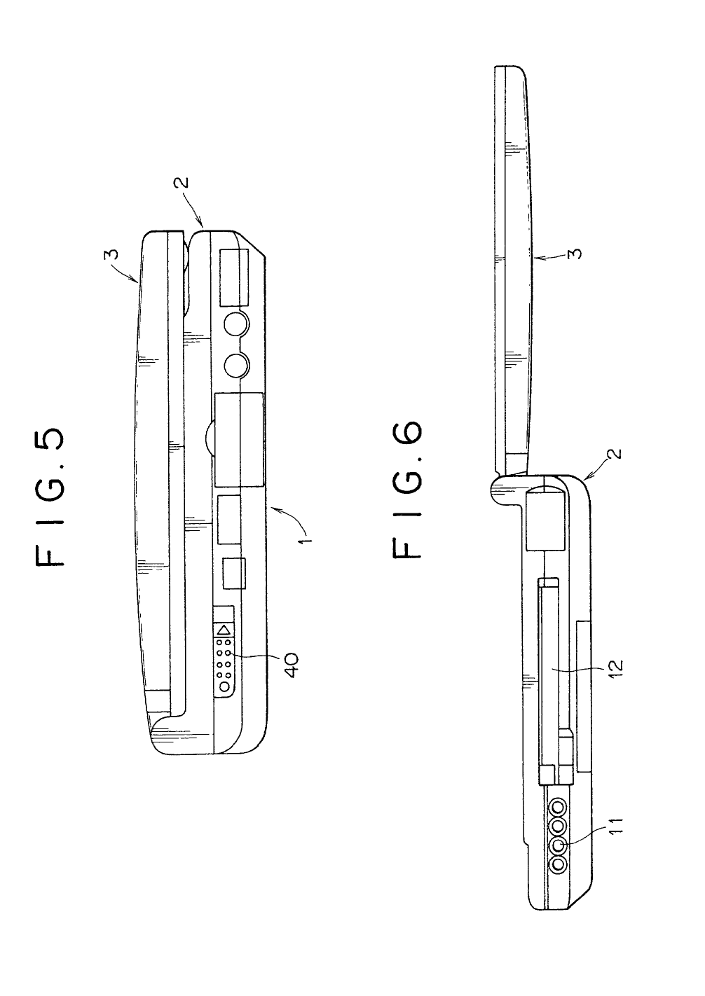

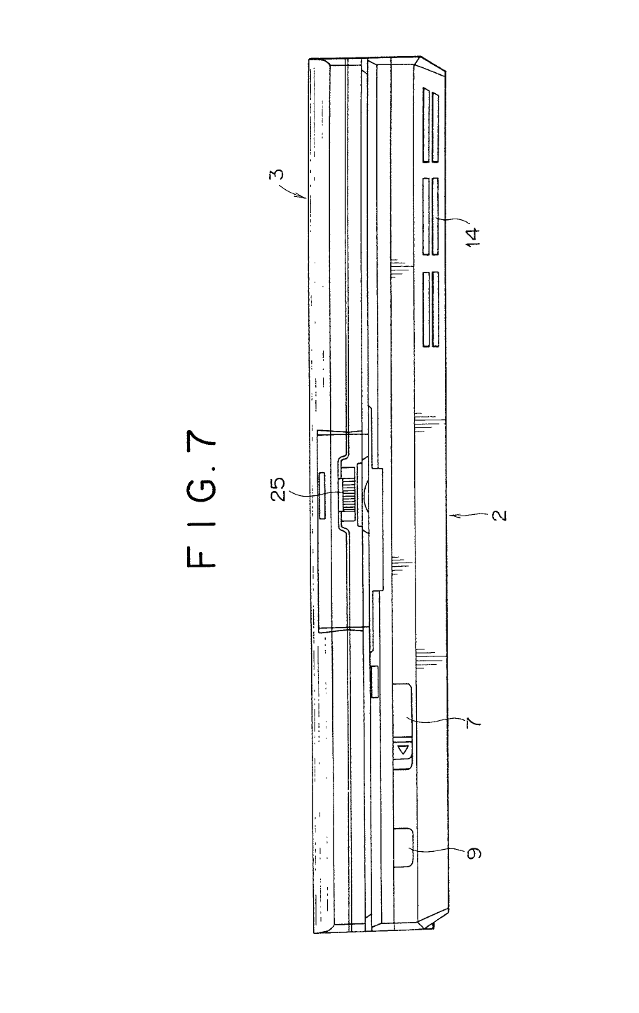

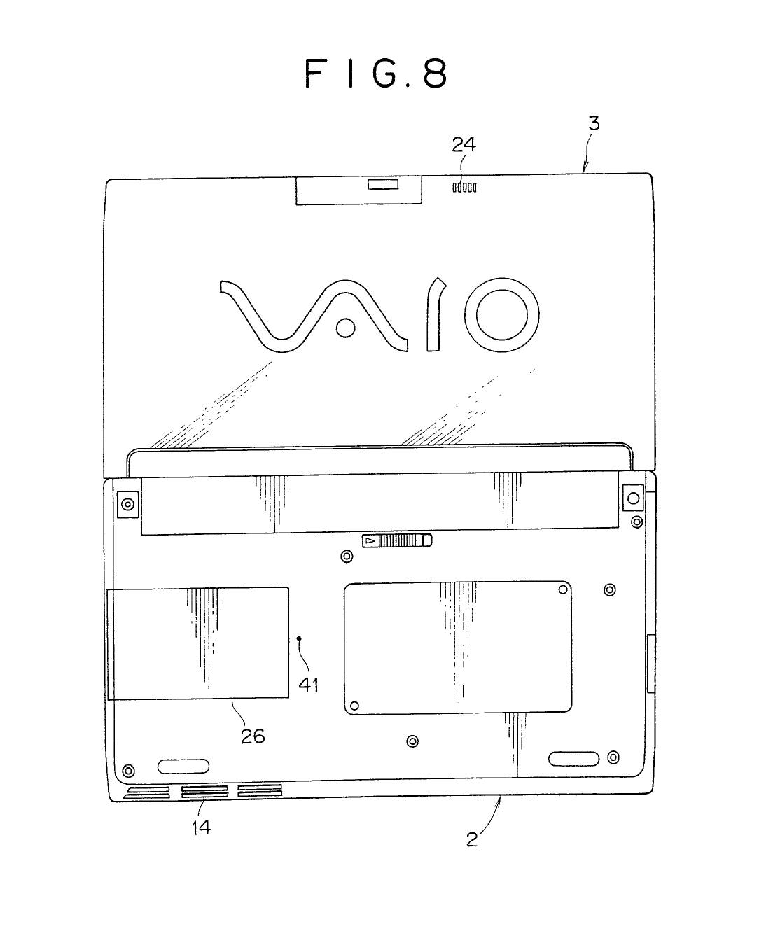

FIGS. 3 through 8 depict structures of a typical portable personal computer to which the invention is applied. The personal computer 1 is a mini-notebook type personal computer that primarily comprises a body 2 and a display part 3 attached swingingly to the body 2. FIG. 3 is a perspective view of the computer with the display part 3 swung open away from the body 2. FIG. 4 is a plan view of the computer in FIG. 3. FIG. 5 is a left-hand side view of the computer with the display part 3 swung shut onto the body 2. FIG. 6 is a right-hand side view of the computer with the display part 3 swung open 180 degrees relative to the body 2. FIG. 7 is a front view of the computer in FIG. 5. FIG. 8 is a bottom view of the computer in FIG. 6.

The face of the body 2 comprises a keyboard 4 and a stick type pointing device 5. The keyboard 4 is used to input characters, symbols, etc., and the stick type pointing device 5 is operated to move a mouse cursor. Also furnished on the body face 2 are a speaker 8 and a shutter button 10 operated to take a picture using the CCD video camera 23 mounted on the display part 3.

A pawl 13 is provided at the upper end of the display part 3. As shown in FIG. 5, with the display part 3 swung closed onto the body 2, the pawl 13 hooks on to a hole 6 in the body 2. At the front of the body 2 is a slide lever 7 furnished in a crosswise movable fashion. The slide lever 7 is used to lock and unlock the pawl 13 so that the pawl 13 is engaged with and disengaged from the hole 6. With the pawl 13 unlocked, the display part 3 may be swung open away from the body 2. Adjacent to the pawl 13 is a microphone 24 which, as depicted in FIG. 8, may pick up sound from both the front and the back side of the body 2.

The front of the body 2 further comprises a programmable power key (PPK) 9. An air outlet 11 is provided on the right-hand side of the body 2, as shown in FIG. 6. At the lower end in front of the body 2 is an air inlet 14 as depicted in FIG. 7. To the right of the air outlet 11 is a slot 12 that accommodates a PCMCIA (Personal Computer Memory Card International Association) card (called a PC card).

An LCD (liquid crystal display) 21 for displaying images is provided on the front of the display part 3. At the upper end of the LCD 21 is an image pickup part 22 mounted rotatably on the display part 3. More specifically, the image pickup part 22 is rotatable to any position within a range of 180 degrees in the same direction as the LCD 21 and in the opposite direction thereof (i.e., toward the back). The image pickup part 22 is furnished with the CCD video camera 23.

At the lower end of the display part 3 on the body side is a group of lamps including a power lamp PL, a battery lamp BL, a message lamp ML and other LEDs. Reference numeral 40 in FIG. 5 denotes a power switch furnished on the left-hand side of the body 2, and reference numeral 25 in FIG. 7 represents an adjusting ring used to adjust the focus of the CCD video camera 23. Reference numeral 26 in FIG. 8 stands for a cover that conceals an opening through which to install an additional memory into the body 2, and reference numeral 41 denotes a small hole through which to insert a pin to unlock the cover 26.

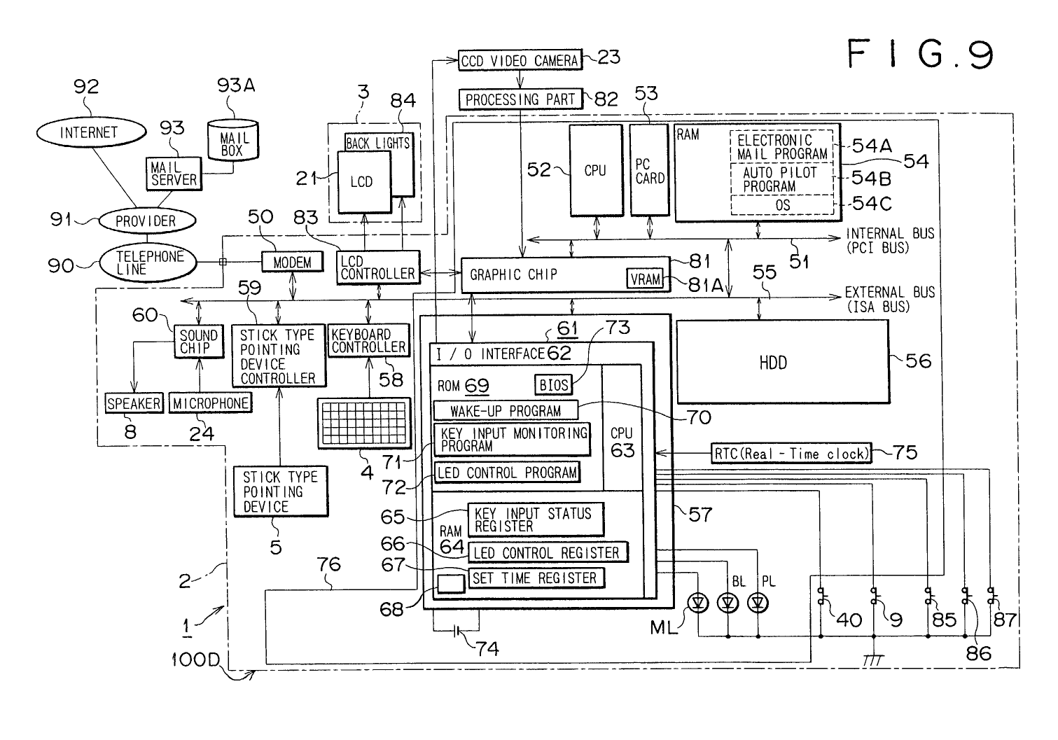

FIG. 9 illustrates an internal structure of the personal computer 1. An internal bus 51 is connected to a CPU (central processing unit) 52, a PC card 53 inserted as needed, a RAM (random access memory) 54, and a graphic chip 81. The internal bus 51 is coupled to an external bus 55. The external bus 55, for its part, is connected to a hard disk drive (HDD) 56, an I/O (input/output) controller 57, a keyboard controller 58, a stick type pointing device controller 59, a sound chip 60, an LCD controller 83, and a modem 50.

The CPU 52 is a controller that controls diverse computer functions. The PC card 53 is installed as needed when an optional function is to be added.

Image data captured by the CCD video camera 23 are forwarded to a processing part 82 for processing. The image data processed by the processing part 82 are input to the graphic chip 81. The graphic chip 81 stores the input video data into an internal VRAM 81A, and retrieves the data from the memory as needed for output to the LCD controller 83. Given the image data from the graphic chip 81, the LCD controller 83 outputs the data to the LCD 21 for display. Back lights 84 are provided to illuminate the LCD 21 from the back.

When the personal computer 1 is booted up, an electronic mail program (an application program) 54A, an auto pilot program (another application program) 54B and the OS (operating program) 54C are transferred from the HDD 56 to the RAM 54 and retained therein.

The electronic mail program 54A is a program that exchanges communication messages with an external entity using a communication line such as a telephone line and by way of a network. A received mail acquisition function is specifically included in the electronic mail program 54A. The received mail acquisition function checks a mail server 93 to see if a mail box 93A therein contains any mail addressed to this program (i.e., to the user). If any such mail is found in the mail box 93A, the received mail acquisition function carries out a suitable process to acquire that mail.

The auto pilot program 54B is a program that starts up and carries out a plurality of predetermined processes (or programs) in a predetermined sequence.

The OS (operating system) 54C controls basic computer functions. Typical operating systems are Windows 95 (registered trademark), Windows 98 (registered trademarks), and the like.

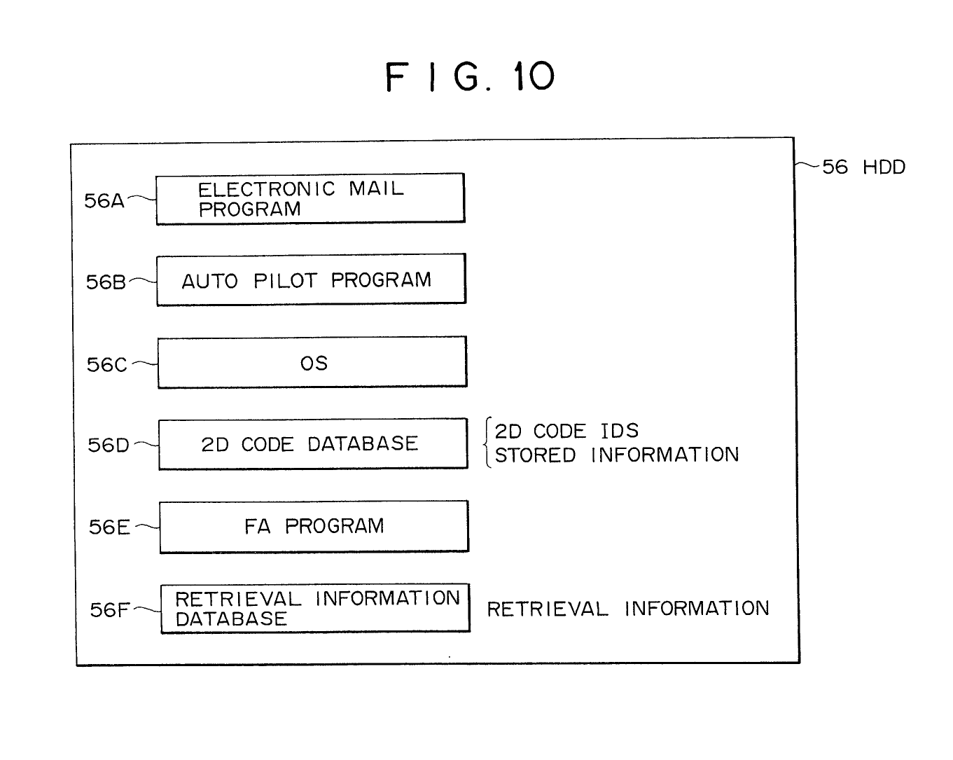

Meanwhile, as shown in FIG. 10, the hard disk drive (HDD) 56 connected to the external bus 55 contains the electronic mail program 56A, auto pilot program 56B, OS (operating system) 56C, a two-dimensional code database (called the 2D code database hereunder) 56D, a finder application program (called the FA program hereunder) 56E, and a retrieval information database 56F.

The 2D code database 56D stores not only 2D code IDs in two-dimensional codes previously registered and attached to floppy disks, such as 2D code IDs of the 2D codes 101-1 through 101-3 fixed respectively to the floppy disks 100-1 through 100-3; but also the names of owners, titles of stored information, dates on which the information was written, and other relevant information (collectively called the stored information hereunder) about the floppy disks 100, the information being stored in correspondence with each of the stored 2D code IDs.

The FA program 56E illustratively carries out processes whereby a given two-dimensional code is extracted from image data held in the VRAM 81A of the graphic chip 81 and a 2D code ID representing the 2D code in question is acquired. In addition, the FA program 56E performs a 2D code retrieval process, to be described later.

The retrieval information database 56F contains retrieval information (described later) needed to execute the 2D code retrieval process.

During the booting process, the OS 56C, auto pilot program 56B and electronic mail program 56A are transferred successively from the hard disk drive 56 to the RAM 54 and stored in the memory.

Returning to FIG. 9, the I/O controller 57 has a microcontroller 61 equipped with an I/O interface 62. The microcontroller 61 is constituted by the I/O interface 62, a CPU 63, a RAM 64 and a ROM 69 which are interconnected. The RAM 64 includes a key input status register 65, an LED (light-emitting diode) control register 66, a set time register 67, and a register 68. The set time register 67 is used to start the operation of a start sequence controller 76 when a time preset by the user (i.e., starting condition) is reached. The register 68 holds a correspondence between a preset combination of operation keys (starting condition) on the one hand and an application program to be started on the other hand. When the user inputs the preset combination of operation keys, the corresponding application program (e.g., electronic mail program) is started.

When the fingertip-operated programmable power key (PPK) 9 is pushed, the key input status register 65 gets and retains an operation key flag. The LED control register 66 is used to control the illumination of the message lamp ML indicating that boot-up status of an application program (e.g., electronic mail program) which is held in the register 68. A desired time of day may be set to the set time register 67.

The microcontroller 61 is connected to a backup battery 74. The battery 74 allows contents of the registers 65, 66 and 67 to be retained when power to the body 2 is turned off.

The ROM 69 in the microcontroller 61 contains in advance a wake-up program 70, a key input monitoring program 71 and an LED control program 72. The ROM 69 is illustratively composed of an EEPROM (electrically erasable and programmable read only memory). The EEPROM is also called a flash memory. The microcontroller 61 is connected to an RTC (real-time clock) 75 that keeps the current time.

The wake-up program 70 in the ROM 69 is a program that checks to see if a preset time in the set time register 67 is reached on the basis of time-of-day data from the RTC 75. When the preset time is reached, the wake-up program 70 starts up a predetermined process (or program). The key input monitoring program 71 continuously monitors whether the PPK 9 is pushed by the user. The LED control program 72 controls the lighting of the message lamp ML.

Furthermore, the ROM 69 contains a BIOS (basic input/output system) 73. The BIOS is a software program that controls exchanges of data (input and output) between the OS or application software on the one hand and peripheral devices (e.g., display part, keyboard, hard disk drive) on the other hand.

The keyboard controller 58 connected to the external bus 55 controls input from the keyboard 4. The stick type pointing device controller 59 controls input from the stick type pointing device 5.

The sound chip 60 receives input from the microphone 24, and supplies sound signals to a built-in speaker 8.

The modem 50 permits connection to a communication network 92 such as the Internet and to the mail server 93 through a public telephone line 90 and an Internet service provider 91.

The power switch 40 is operated to turn on and off the power supply. A half-push switch 85 is activated when the shutter button 10 is half-pushed. A full-push switch 86 is turned on when the shutter button 10 is fully pushed. A reverse switch 87 is turned on when the image pickup part 22 is rotated by 180 degrees (i.e., when the CCD video camera 23 is rotated into a direction suitable for picking up an image on the opposite side of the LCD 21).

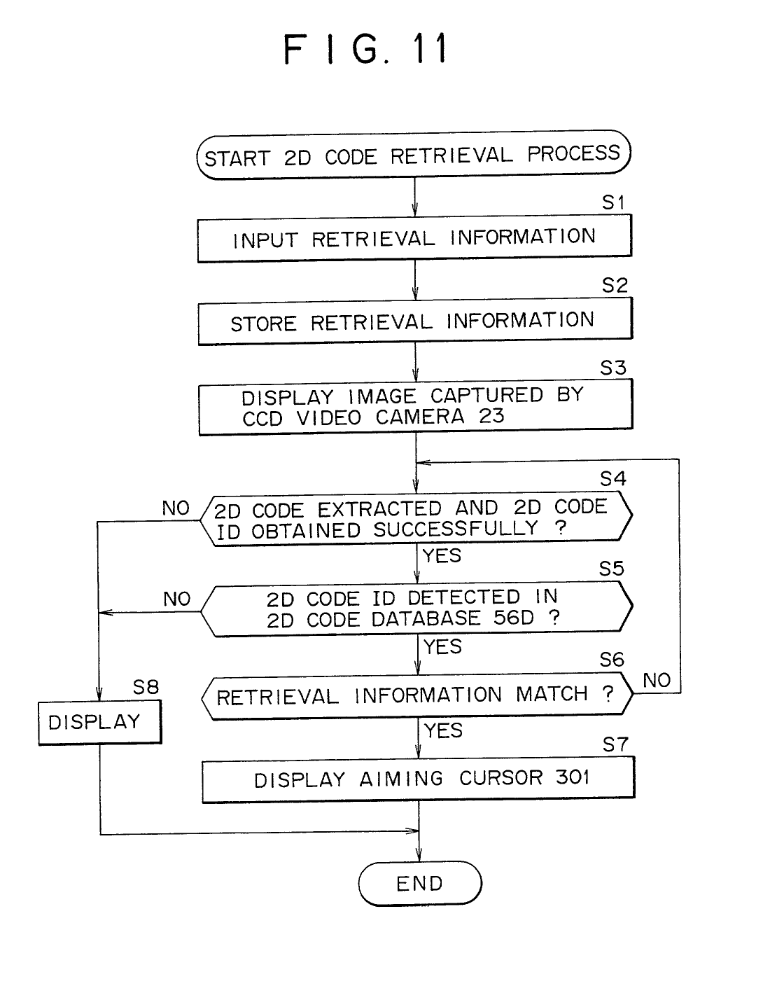

How the FA program 56E performs its 2D code retrieval process will now be described with reference to the flowchart of FIG. 11.

The FA program 56E is first started from the HDD 56. In step S1, the user operates the keyboard 4 or stick type pointing device 5 to input information necessary for retrieving a desired floppy disk (called retrieval information). Retrieval information constitutes at least one of a plurality of categories of information held in the 2D code database 56D, representing illustratively a title name, a write date and the owner's name regarding each floppy disk.

The input of retrieval information in step S1 is followed by step S2. In step S2, the FA program 56E (CPU 52) stores the retrieval information into the retrieval information database 56F.

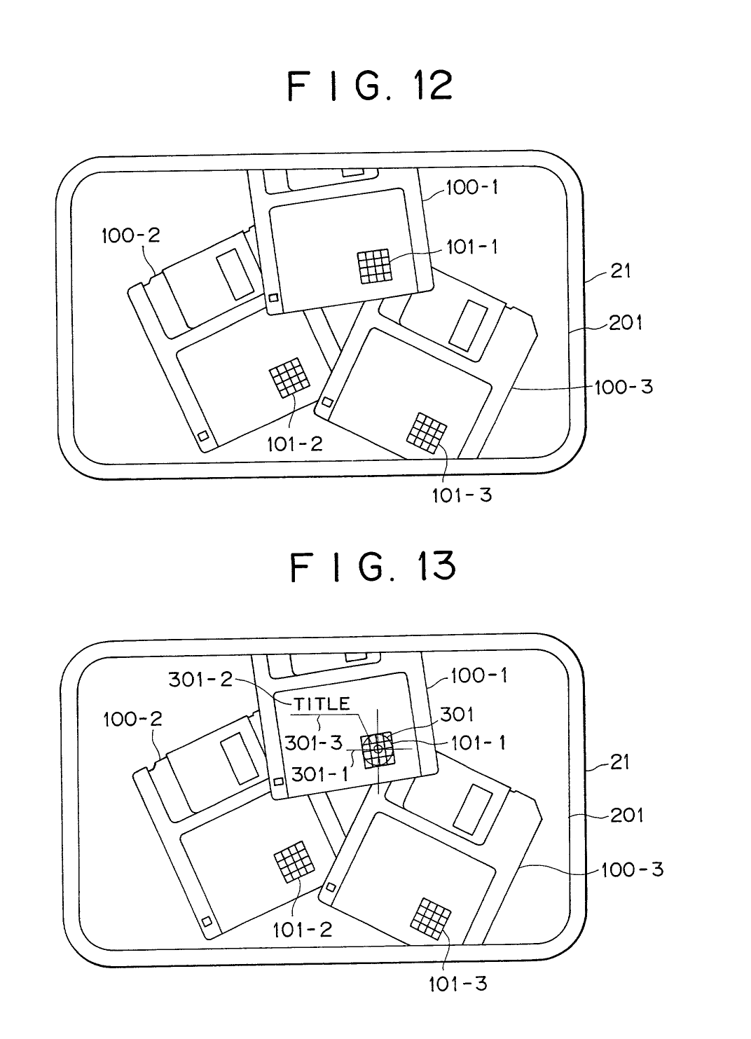

In step S3, the FA program 56E causes the CCD video camera 23 to start taking a picture and gets the processing part 82 to process image data acquired. While writing the image data to the VRAM 81A in the graphic chip 81, the FA program 56E causes the LCD controller 83 to display an image constituted by the image data onto a finder screen 201 of the LCD 21 as shown in FIG. 12. In the example of FIG. 12, the finder screen 201 shows an image, captured by the CCD video camera 23, of three floppy disks 100-1 through 100-3 bearing 2D codes 101-1 through 101-3 respectively.

In step S4, the FA program 56E extracts 2D codes from the image data acquired by the CCD video camera 23 in step S3, and obtains 2D code IDs corresponding to the acquired 2D codes. If a 2D code and its corresponding 2D code ID are successfully acquired in step S4, step S5 is reached. In step 5, suitable image processing is carried out on the image data representing the displayed image from top left to bottom right on the finder screen 201.

More specifically, a check is made in step S4 to see if a 2D code 101-i (i=1, 2, 3 in the example of FIG. 12) is extracted and the corresponding 2D code ID is obtained. If the 2D code and the corresponding 2D code ID are successfully obtained, step S5 is reached. In step S5, the FA program 56E searches the 2D code database 56D for the 2D code ID acquired in step S4. If the 2D code ID in question is found to exist in the 2D code database 56D, step S6 is reached.

In step S6, the FA program 56E further searches through the 2D code database 56D to see if the stored information held in correspondence with the 2D code ID acquired in step S4 includes the retrieval information placed into the retrieval information database 56F in step S2. (When the stored information is found to include the retrieval information, the detected inclusion is referred to as a match of the retrieval information.) If a match of the retrieval information is detected, step S7 is reached.

In step S7, the FA program 56E causes the LCD controller 83 to acquire information (coordinate information) about a position showing the 2D code 101-i (i=1 in the example of FIG. 13) extracted in step S4, and to display an aiming cursor 301 on the finder screen 201 in corresponding relation to the acquired coordinate information. The aiming cursor 301 is made up of three elements: an aiming geometry 301-1 (crossing lines, with their point of intersection encircled by two concentric circles) allowing the user to have a sense of aiming at the 2D code in question; a title name 301-2 (indicated as “TITLE” in FIG. 13) forming part of the retrieval information placed into the retrieval information database 56F in step S2; and a leader line 301-3 emphasizing the title name 301-2. When the cursor 301 is displayed, the process is terminated. By referencing the aiming cursor 301, the user is able to recognize the desired floppy disk.

If in step S6 a mismatch of the retrieval information is detected, step S4 is reached again. In step S4, another attempt is made to obtain another 2D code and its corresponding 2D code ID. Step S4 and subsequent steps are repeated as many times as needed. In this manner, all 2D codes that may exist in the image data captured by the CCD video camera 23 are extracted and the 2D code IDs corresponding to the extracted 2D codes are acquired.

Step S8 is reached in one of two cases. In one case, the attempt to obtain a 2D code and/or its corresponding 2D code ID has failed in step S4, i.e., all 2D codes have been extracted from the image data obtained in step S3 and no more 2D code is judged to exist. In another case, the 2D code ID acquired in step S4 is judged to be nonexistent in the 2D code database 56D in step S5. With step S8 thus reached, the FA program 56E causes the LCD controller 83 to display on the finder screen 201 a message indicating the failure of code extraction and/or the absence of a matching 2D code ID. Thereafter the process is terminated.

As described, floppy disks 100 are provided with labels bearing 2D codes 101 registered in correspondence with previously stored information. Simply taking a picture of such floppy disks allows the user to pick one including desired information corresponding to the entered retrieval information.

A computer program designed to perform the above-described processes may be retained not only on such package media as floppy disks, CD-ROMs and DVDs; but also on semiconductor memories, magnetic disks and the like where the program is stored temporarily or permanently; on wired and wireless communication media such as local area networks, the Internet, digital satellite broadcasting networks; or in diverse communication interfaces such as routers and modems for transmitting or receiving the program offered by the foregoing media. Such media, networks, interfaces and other measures allow the program to be installed in computers for program execution. The image processing program storage medium as mentioned in this specification refers broadly to all such media, networks, interfaces and measures.

As described and according to the inventive image processing apparatus, image processing method and storage medium above, an item of identification information representing each of a plurality of predetermined image patterns is recognized from a captured object image. Of the multiple items of identification information thus recognized, one that corresponds to previously input retrieval information is retrieved. A cursor reflecting the retrieved identification information is displayed in a position corresponding to the image pattern being displayed. With suitable image patterns such as 2D codes attached to goods and articles, it is easy for the user to pick what he or she is looking for.

As many apparently different embodiments of this invention may be made without departing from the spirit and scope thereof, it is to be understood that the invention is not limited to the specific embodiments thereof except as defined in the appended claims.

What is claimed is:

1. An image processing apparatus comprising:
image acquiring means for acquiring an object image;
displaying means for displaying said object image acquired by said image acquiring means;
identification information recognizing means for recognizing, from said object image acquired by said image acquiring means, identification information representing each of a plurality of predetermined image patterns;
retrieving means for retrieving, based on previously input retrieval information, identification information coinciding with said identification information recognized by said identification information recognizing means; and
cursor display controlling means for displaying, based on results of the retrieving by said retrieving means, a cursor in a position corresponding to the predetermined image pattern displayed by said displaying means.

2. An image processing apparatus according to claim 1, wherein said identification information recognizing means extracts each of a plurality of visible codes attached to a plurality of objects from said object image acquired by said image acquiring means, said identification information recognizing means further recognizing identification information representing an image pattern corresponding to each of said plurality of visible codes.

3. An image processing apparatus according to claim 1, wherein said identification information recognizing means extracts each of a plurality of two-dimensional codes attached to a plurality of objects from said object image acquired by said image acquiring means, said identification information recognizing means further recognizing identification information representing an image pattern corresponding to each of said plurality of two-dimensional codes.

4. An image processing apparatus according to claim 1, further comprising position information detecting means for detecting relative position information on said predetermined image pattern displayed relative to said object image acquired by said image acquiring means;
wherein said cursor display controlling means draws a cursor image in a display area position corresponding to said relative position information detected by said position information detecting means, said cursor image representing said results of said retrieving by said retrieving means.

5. An image processing apparatus according to claim 4, wherein said cursor display controlling means draws said cursor image in superposed relation to said object image displayed in a predetermined display area by said displaying means for displaying an object image, said cursor image representing said results of said retrieving by said retrieving means.

6. An image processing method comprising the steps of:
acquiring an object image;
displaying said object image acquired in said image acquiring step;
recognizing, from said object image acquired in said image acquiring step, identification information representing each of a plurality of predetermined image patterns;
retrieving, based on previously input retrieval information, identification information coinciding with said identification information recognized in said identification information recognizing step; and
controlling display of a cursor, based on results of the retrieving in said retrieving step, in a position corresponding to the predetermined image pattern displayed in said displaying step.

7. An image processing program storage medium for storing an image processing program in a manner executable by a computer, said image processing program comprising the steps of:
acquiring an object image;
displaying said object image acquired in said image acquiring step;
recognizing, from said object image acquired in said image acquiring step, identification information representing each of a plurality of predetermined image patterns;
retrieving, based on previously input retrieval information, identification information coinciding with said identification information recognized in said identification information recognizing step; and
controlling display of a cursor, based on results of the retrieving in said retrieving step, in a position corresponding to the predetermined image pattern displayed in said displaying step.
